(19) United States
(12) Patent Application Publication
(10) Pub. No.: US 2005/0249527 A1
(43) Pub. Date: Nov. 10, 2005

(54) Transport belt and image forming apparatus using the same

(75) Inventor: Shinichi Kuramoto, Kanagawa (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 11/008,210

(22) Filed: Dec. 10, 2004

(30) Foreign Application Priority Data
May 6, 2004 (JP) P 2004-137577

(51) Int. Cl. G03G 15/01

(52) U.S. Cl. 399/302

(57) ABSTRACT

A transport belt of the invention is characterized by including a belt substrate including an elastic material, and a coating layer for coating the surface of the belt substrate, and is capable of directly or indirectly carrying an image formed by an image-forming particle. The coating layer has a thickness “h,” which is equal to or smaller than an average particle size “d” of the image-forming particle. A hardness-retaining filler which is capable of suppressing a drop in surface microhardness is dispersed in the coating layer.

### BACKGROUND OF THE INVENTION

1. Field of the Invention

The present invention relates to a transport belt for use in an image forming apparatus, such as a copier, printer, or facsimile apparatus. More particularly, the invention relates to an improvement in a transport belt configured such that a surface of a belt substrate made from an elastic material is coated with a coating material, as well as to an image forming apparatus using the same.

2. Description of the Related Art

An image forming apparatus, such as a copier, a printer, and a facsimile apparatus, have already been provided as examples of an image forming apparatus in which an image is formed on an image carrier such as a photosensitive drum, to thus transfer the image to a recording material indirectly by way of an intermediate transfer belt, or as examples of an image-forming apparatus, wherein the image is directly transferred to a recording material provided on a recording material holding belt.

In view of maintaining favorable transfer efficiency of an image from an image carrier, a transport belt of this type (an intermediate transfer belt or a recording material holding belt) must have sufficient pressure and improved adhesiveness in a nip region between the transport belt and the image carrier as well as in a nip region between the transport belt and a transfer member.

To achieve the above, a transport belt whose belt material per se is made of an elastic material such as a flexible rubber material has already been provided.

For a transport belt using an elastic material of this type, there is generally employed a configuration such that a coating layer having superior releasability is formed on the surface of the belt material (for instance, a fluorine-based coating material is used). However, when the transport belt of this type is stretched in a tensioned manner, the coating layer is difficult to be elastically deformed in pursuant to the belt substrate formed from an elastic material, as a result of which cracks inevitably develop in the coating layer.

Under such a condition, a residual toner penetrates into a crack region of the coating layer, and the thus-penetrating residual toner cannot be scraped off by a cleaning member, such as a cleaning blade or brush. This may result in faulty cleaning of the transport belt.

As a method to solve the problem, there has already been proposed a technique where the thickness of a coating layer in a transport belt (transfer belt) is rendered smaller than the particle size of a toner. Accordingly, even when cracks have arisen in the coating layer, the toner does not become completely embedded in the cracks, and can be easily scraped off by a cleaning member (see, e.g., JP-A-8-305181).

As another solution, there has already been proposed a technique, wherein an elongation ratio of a coating layer at the time when a crack is produced is set to 20% or higher, thereby preventing accumulation and adhesion of residual toner particles onto a crack region in a transport belt (see, e.g., JP-A-2000-310912).

However, the transport belt disclosed in JP-A-8-305181 is involves a technical problem that, even when the thickness of the coating layer is reduced, the coating layer absorbs moisture in a high temperature/high humidity environment, thereby lowering hardness of the coating layer per se. As a result, a crack region of the coating layer is also softened, which makes it difficult to scrape off residual toner particles trapped in the crack region.

Meanwhile, since the transport belt disclosed in JP-A-2000-310912 is used while being strongly stretched, permanent set of the transport belt is deteriorated, which may adversely affect registration.

Furthermore, in a configuration where the transport belt is installed while being stretched strongly so as to render the coating layer smooth, the coating layer may be prone to time-varying deterioration.

Furthermore, when a thermoplastic resin such as a fluorine-based coating material is used as the coating layer, the transport belt is prone to deformation such as curling. As a result, the image forming apparatus is prone to a secondary problem, such as occurrence of a white spot phenomenon in the course of transfer.

### SUMMARY OF THE INVENTION

The present invention has been made in view of the above circumstances and provides a transport belt, which is predicted on usage of a belt substrate made from an elastic material, capable of effectively preventing accumulation and adhesion of image-forming particles into cracks arisen in a coating layer and, moreover, effectively suppressing deformation and deterioration of the belt per se, as well as providing an image forming apparatus using the same.

According to a first aspect of the invention, a transport belt which can carry an image formed by an image-forming particle, includes a belt substrate comprising an elastic material and a coating layer coating a surface of the belt substrate, in which the coating layer has a thickness which is equal to or smaller than an average particle size of the image-forming particle, and a hardness-retaining filler capable of suppressing a drop in surface microhardness is disposed in the coating layer.

### BRIEF DESCRIPTION OF THE DRAWINGS

FIG. 1A is a descriptive view showing general features of a transport belt according to the present invention, and FIG. 1B is a descriptive view showing general features of an image-forming apparatus according to the invention;

FIG. 2A is a descriptive view showing the overall configuration of an image-forming apparatus according to a first embodiment, and FIG. 2B is a descriptive view showing a cross-sectional structure of an intermediate transfer belt (transport belt);

FIG. 3A is a descriptive view showing a structure of a coating layer in the intermediate transfer belt, and FIG. 3B is a descriptive view showing effects of the coating layer in the intermediate transfer belt;

FIG. 4A is a descriptive view showing a thickness of an intermediate transfer belt used in the first embodiment, FIG. 4B is a descriptive view showing a relationship between a crack region and a residual toner in the coating layer, and FIG. 4C is a descriptive view showing a relationship between a crack region and a residual toner in the coating layer in an intermediate transfer belt used in a comparative embodiment;

FIG. 5 is a descriptive view showing a structure of an intermediate transfer belt employed in a second embodiment;

FIG. 6 is a descriptive view showing effects of the intermediate transfer belt employed in the second embodiment;

FIG. 7 is a descriptive view showing evaluation results of cleaning performance in a variety of environments of example 1 where filling factors of carbon black in a coating layer are varied;

FIG. 8 is a descriptive view showing a change in surface microhardness in a variety of environments of example 2 and a comparative example;

FIG. 9 is a descriptive view showing a measurement principle of surface microhardness; and

FIG. 10 is a descriptive view showing a relationship between surface microhardness of the coating layer and transfer efficiency in example 3.

### DETAILED DESCRIPTION OF THE PREFFERED EMBODIMENTS

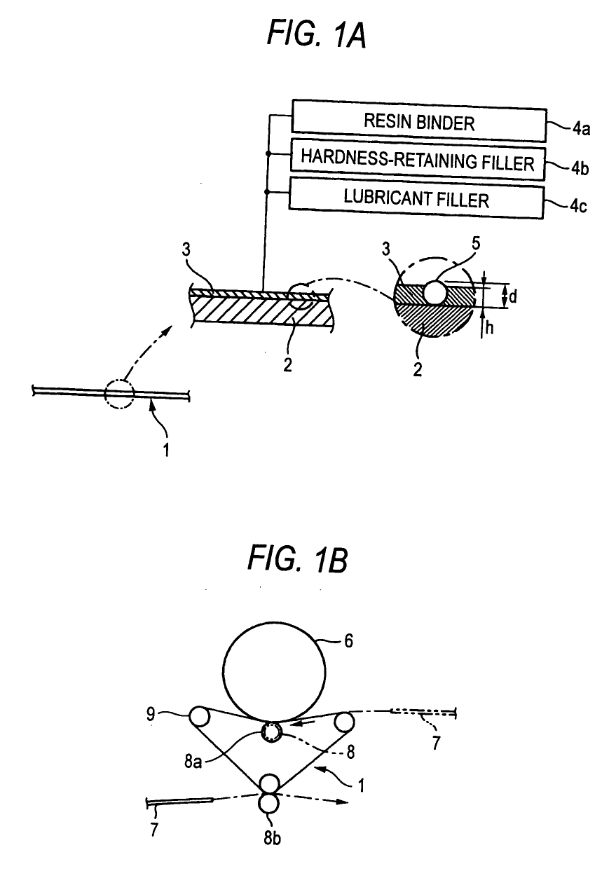

The invention provides a transport belt 1 which includes, as shown in FIG. 1A, a belt substrate 2 made from an elastic material, and a coating layer 3 for coating a surface of the belt substrate 2; and being capable of directly or indirectly carrying an image formed by an image-forming particle 5. The coating layer 3 has a thickness “h,” which is equal to or smaller than an average particle size “d” of the image-forming particle 5. A hardness-retaining filler 4b which is capable of suppressing a drop in surface microhardness is dispersed in the coating layer 3.

In relation to such technique method, any material may be appropriately selected for the transport belt 1, so long as it includes the belt substrate 2 made from an elastic material. When an image-forming apparatus is taken as an example, examples of the transport belt 1 include an intermediate transfer belt or a recording-material-holding belt.

The only requirement for the belt substrate 2 is to use an elastic material, and addition of a variety of additives, such as a conductive filler for adjusting electrical resistance, to the belt substrate does not raise any problem. Here, an elastic material is a material having mechanical characteristic to be returned to an original state when pulling it in a mechanical manner. An arbitrary elastic material may be appropriately selected for the belt substrate 2. An elastic material whose Young's modulus is 8 MPa or lower is preferable. An elastic material whose Young's modulus is 2.8 MPa to 3.8 Mpa is more preferable. More preferably, the belt substrate 2 has rupture strength in accordance with JIS K6251 of 10 MPa or more, tearing strength in accordance with JIS K6251 of 20 kN/m or more, hardness in accordance with JIS K6253 of 68° to 780, elongation in accordance with JIS K6251 of 300% or more and permanent elongation in accordance with JIS K6251 of 5% or more.

The only requirement for the coating layer 3 is to cover the surface of the belt substrate 2. A resin binder 4a in which a variety of fillers, including a lubricant filler 4c for inducing lubricity, are dispersed is usually used. Moreover, the coating layer 3 may be either a single layer or a multilayer.

Here, any binders can be selected as appropriate for the resin binder 4a. However, a polyurethane resin, a polyester resin, or an acrylic resin is typically used.

In particular, in the invention, the coating layer 3 have a thickness “h” which is equal to or smaller than an average particle size “d” of the image-forming particle 5.

In this case, even when a crack is produced in the coating layer 3 and the image-forming particle 5 penetrates into the crack, the image-forming particle in the crack can be scraped off by a cleaning member or can be collected by application of an electrostatic charge. Therefore, accumulation of the image-forming particle 5 in the crack in the coating layer 3 can be prevented, whereby contamination of the transport belt 1 can be suppressed.

In the configuration, the thickness of the coating layer 3 may be selected as appropriate. However, when the thickness is smaller than 3 μm, problems (e.g., exfoliation of the coating layer 3) resulting from wear of the coating layer 3 may occur. Therefore, the coating layer 3 preferably has a thickness of 3 μm or more.

In addition, in the invention, the hardness-retaining filler 4b which is capable of suppressing a drop in surface microhardness is dispersed in the coating layer 3.

When a predetermined amount of the hardness-retaining filler 4b is dispersed in the resin binder 4a, even when the coating layer 3 absorbs moisture, hardness of the coating layer 3 per se is not lowered; consequently, a crack produced in the coating layer 3 maintains its shape without the coating layer 3 being softened.

A filler including at least one of a conductive filler and insulating filler may be selected as appropriate for the hardness-retaining filler 4b. In this case, conductivity (resistance) can be adjusted by adding a conductive filler, as required. Furthermore, in a case where resistance of a transport belt 1 does not require adjustment, a configuration in which only an insulating filler is dispersed is also applicable.

Meanwhile, the hardness-retaining filler 4b is not necessarily a single filler; a plurality of hardness-retaining fillers may be used. Furthermore, the hardness-retaining filler 4b may also exhibit other functions in addition to a function of hardness retention. Furthermore, any shapes and particle sizes may be selected as appropriate.

Any filling factor of the hardness-retaining filler 4b may be selected as appropriate, so long as it falls within a range where a decrease in surface microhardness of the coating layer 3 can be suppressed. However, when the filling factor of the hardness-retaining filler 4b is excessively low, the surface microhardness of the coating layer 3 will be decreased. For this reason, the filling factor is preferably 5 wt % or more based on the total weight of the resin binder.

Meanwhile, no particular limitation is imposed on the upper limit of a filling factor of the hardness-retaining filler 4b. However, an upper limit, such as 50 wt %, may be selected as appropriate, in consideration of deterioration of leakage resistance and a drop in tear strength.

Filling the hardness-retaining filler 4b into the coating layer 3 is also preferable, in that environmental conditions are less likely to affect the surface microhardness of the coating layer.

A preferred surface microhardness of the coating layer 3 suppresses to 20% or lower a difference between a hardness measurement value obtained in a hot and humid environment and a hardness measurement value obtained in a cool and low-humidity environment, as measured with use of, for instance, DUH-201S dynamic ultramicrohardness meter (manufactured by Shimadzu Corp.) using a triangular pyramid indenter having a ridge angle of 115°.

Furthermore, in the invention, the transport belt 1 includes those in which a coating layer 3 is formed on the surface of a belt substrate 2 made from an elastic material. For instance, the transport belt 1 may include a coating layer (unillustrated) which coats the backside of the belt substrate 2.

In a configuration equipped with the backside coating layer as described above, direct contact between the face of the belt substrate 2 and the backside member can be prevented. Accordingly, time-varying changes, such as bleeding from the belt substrate 2, or environmental damages attributable to ozone or NOₓ can be suppressed.

The present invention is intended for application to the transport belt 1; however, the invention is not limited thereto, and can also applied to an image-forming apparatus using the transport belt 1.

In this case, the present invention provides an image-forming apparatus which includes, as shown in FIG. 1B, an image carrier 6, and a transport belt 1 opposing the image carrier 6, and in which a toner image formed on the image carrier 6 is transferred onto the transport belt 1 or onto a recording material 7 on the transport belt 1, in which the described transport belt is used as the transport belt 1.

The invention is particularly advantageous for an image-forming apparatus configured to include a cleaning member (unillustrated) for scraping off a residual image-forming particle 5 on the transport belt 1.

Here, in a configuration where the transport belt 1 is used as an intermediate transfer belt, as shown in FIG. 1B, the toner image on the image carrier 6 is transferred to the transport belt (an intermediate transfer belt) 1 as primary transfer by a primary transfer device 8a, and thereafter the toner image on the transport belt (an intermediate transfer belt) 1 is transferred to the recording material 7 as secondary transfer by a secondary transfer device 8b.

Meanwhile, in a configuration where the transport belt 1 is used as the recording material holding belt., as shown in FIG. 1B, the recording material 7 is held on the transport belt (recording material holding belt) 1, and thereafter the toner image on the image carrier 6 is transferred to the recording material 7 on the transport belt (recording material holding belt) 1 by the transfer device 8.

In the image-forming apparatus shown in FIG. 1B, a preferable configuration is such that the transport belt 1 is stretched in a tensioned manner by a plurality of tension rollers 9 and is disposed, in a contacting manner, along the contour of the image carrier 6 having a drum-like shape.

According to the configuration, by disposing the transport belt 1 along the contour of the image carrier 6 to the extent possible, discharge in unnecessary gaps in the vicinity of a nip region in the course of transfer can be prevented, whereby splashing of the toner image can be prevented.

In addition, in the image-forming apparatus shown in FIG. 1B, a configuration wherein either one of the image carrier 6 or the transport belt 1 serves as a driving source, thereby causing the other to rotate, is preferable.

According to the configuration, when such a driving constitution is employed, a driving mechanism of the other element can be eliminated, whereby driving cost therefor can be suppressed. In addition, there can be eliminated variable factors, such as a variation in thickness of the transport belt 1 resulting from driving interference between the transport belt 1 and the image carrier 6, or variations in a feed in the processing direction.

According to the invention, in a configuration where a surface of a belt substrate made from an elastic material is coated with a coating layer, the thickness of the coating layer is set equal to or smaller than an average particle size of an image-forming particle; and a hardness-retaining filler being capable of suppressing a drop in surface microhardness is dispersed in the coating layer. As a result, even when a crack has developed in the coating layer, the crack per se can be maintained shallow in depth, and, furthermore, the shape of the crack can be maintained without softening.

Accordingly, even when an image-forming particle penetrates into the crack region in the coating layer, the image-forming particle can be scraped off by a cleaning member easily and without fail.

Therefore, the surface of the transport belt is not contaminated, and accordingly, stable image quality can be maintained.

In addition, according to the image-forming apparatus making use of the above-mentioned transport belt, there can be easily constructed an image-forming apparatus which can maintain stable image quality without contaminating the surface of the transport belt.

Hereafter, the present invention will be described in detail on the basis of embodiments illustrated in the drawings.

### First Embodiment

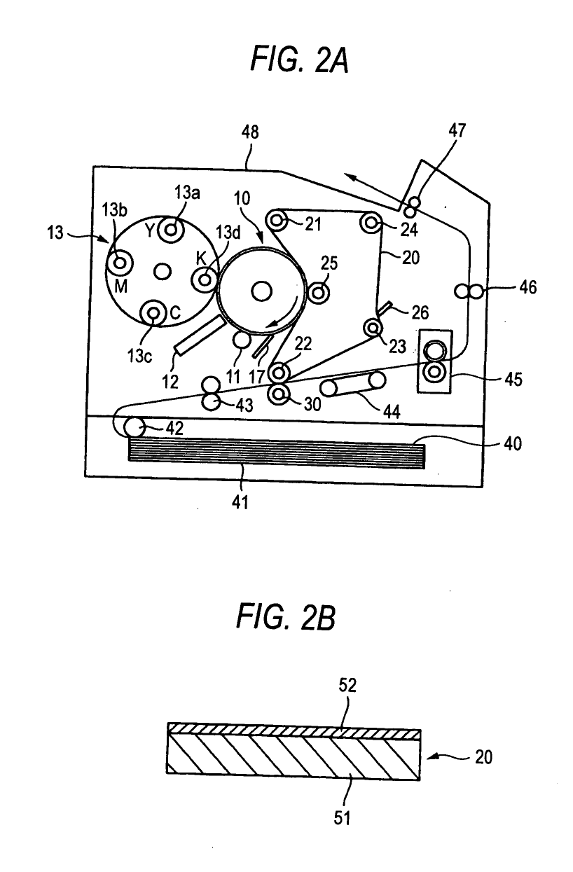

FIG. 2A is a view showing an embodiment of an image-forming apparatus to which the present invention is applied.

As shown in the drawing, the image-forming apparatus includes a photosensitive drum 10, and an intermediate belt 20 which comes in contact with the photosensitive drum 10 along the contour of the photosensitive drum 10 in a predetermined region for effecting transfer of a toner image from the photosensitive drum 10.

In the embodiment, the photosensitive drum 10 includes a photosensitive layer whose resistance value is lowered upon irradiation with light. On the periphery of the photosensitive drum 10, there are disposed an charging device 11 for charging the photosensitive drum 10; an exposure device 12 for forming electrostatic latent images of respective color components (in the embodiment, yellow, magenta, cyan, and black) on the electrified photosensitive drum 10; a rotary developing device 13 for forming visible images of the respective color toners from the respective color latent images formed on the photosensitive drum 10; the intermediate transfer belt 20; and a cleaning device 17 for cleaning residual toner on the photosensitive drum 10.

As the charging device 11, for instance, a charging roller is employed. However, a charger such as a corotron may be employed.

An essential requirement for the exposure device 12 is to be capable of writing an image on the photosensitive drum 10 with use of light. In the embodiment, for instance, a print head that employs an LED is employed; however, the exposure device 12 is not limited thereto. A print head that employs an EL, a scanner for performing scanning with a laser beam with use of a polygon mirror, or the like, may be selected as appropriate.

Furthermore, the rotary developing device 13 is configured such that developing devices 13a to 13d in which the respective color toners are housed are rotatably mounted, and an arbitrary rotary developer may be selected as appropriate so long as, for instance, the rotary developer can cause respective color toners to adhere to portions on the photosensitive drum 10 where potential is lowered upon exposure. No particular limitation is imposed on a shape and particle size of the toners, so long that the toner can be applied accurately on an electrostatic latent image. The rotary developing device 13 is employed in the embodiment; however, four separate developing devices may be employed instead.

Still furthermore, the cleaning device 17 may be selected arbitrarily, so long as it is able to clean a residual toner on the photosensitive drum 10. Examples of the cleaning device 17 include that adopting a blade cleaning method. However, in a case where toner of high transfer efficiency is employed, there may also be adopted a configuration which does not use the cleaning device 17.

As shown in FIG. 2A, the intermediate transfer belt 20 is wrapped around four tension rollers 21 to 24. The intermediate transfer belt 20 is brought into close contact with the photosensitive drum 10 located between the rotary developing device 13 and the cleaning device 17 only in a predetermined contact region and in such a manner as to come in contact with the photosensitive drum 10 along the face thereof.

Here, the intermediate transfer belt 20 and the photosensitive drum 10 may be driven independently by separate driving systems. However, in the embodiment, the intermediate transfer belt 20 is, as will be described later, an elastic belt, and, furthermore, is positioned so as to come into contact with the photosensitive drum 10 along the periphery thereof. Accordingly, the intermediate transfer belt 20 is, for instance, rotated by driving force of the photosensitive drum 10 serving as the driving source.

On a portion of the contact region where the intermediate transfer belt 20 is in close contact with the photosensitive drum 10, a primary transfer roller 25 serving as a primary transfer device is disposed in a contacting manner from the backside of the intermediate transfer belt 20, with a predetermined primary transfer bias applied thereto.

Furthermore, at a portion of the intermediate transfer belt 20 opposing the tension roller 22, a secondary transfer roller 30 serving as a secondary transfer device is located in an opposing manner with the tension roller serving as a back-up roller. For instance, a predetermined secondary transfer bias is applied to the secondary transfer roller 30, and the tension roller 22 which also functions as the back-up roller is grounded.

Still furthermore, at a portion of the intermediate transfer roller opposing the tension roller 23, a cleaning blade 26 serving as a cleaning device is disposed. The cleaning blade 26 scrapes and removes residual toner on the intermediate transfer belt 20. In the embodiment, a metal scraper, a cleaning brush, or a cleaning roller may be employed in place of the cleaning blade 26; or a predetermined cleaning bias may be applied on the cleaning blade 26 or the like as required. As a matter of course, a cleaning brush or the like may be employed in combination with the cleaning blade 26.

Meanwhile, a recording material 40 such as paper is housed in a supply tray 41. The recording material 40 is supplied by a pick-up roller 42, thereafter guided to a secondary transfer section by way of a registration roller 43, transported to a fixing device 45 by way of a transfer belt 44, and discharged to a discharge tray 48 by way of a transfer rollers 46 and 47.

In the embodiment, the intermediate transfer belt 20 includes, as shown in FIG. 2B, a belt substrate 51 comprises an elastic material, and a coating layer 52 for coating the surface of the belt substrate 51.

Examples of the belt substrate 51 used in the embodiment include vulcanized rubber and thermoplastic elastomer. Examples of a raw rubber material include general diene rubbers; for instance, a styrene-butadiene rubber (SBR), a polyisoprene rubber (IIR), an ethylene-propylene-diene rubber (EPDM), a polybutadiene rubber (BR), and an acrylic rubber (ACM, ANM). However, an acrylonitrile-butadiene rubber (NBR), a hydrogenated NBR, a chloroprene rubber (CR), an epichlorohydrin rubber (CO, ECO), polyurethane rubber (PUR), or the like, is preferable, in view of such a material having a comparatively high rigidity, having a volume resistivity which is close to that of a semiconductor, and having favorable fluidity in a molding die.

Meanwhile, as the thermoplastic elastomer, there is employed a polyester thermoplastic elastomer, a polyurethane thermoplastic elastomer, a styrene-butadiene triblock thermoplastic elastomer, a polyolefin thermoplastic elastomer, or the like. When such a thermoplastic elastomer is employed, the belt substrate can be recycled, which is favorable from the viewpoint of environmental safety.

Furthermore, a material for the belt substrate 51 is not necessarily of a single type; two or more types of materials may be blended. For instance, a material in which a chloroprene rubber (CR) and EPDM are blended can be used. Examples other than EPDM include NBR, SBR, isoprene, and Si.

By adding a conductive filler or an insulating filler to the belt substrate 51, the volume resistivity of the belt substrate 51 can be adjusted.

The respective fillers may be of an arbitrary shape, such as a particulate shape or an elongated-fiber shape. Examples of the conductive fillers include carbon black, Ketjen black, acetylene black, zinc oxide, potassium titanate, titanate potassium, titanium oxide, tin oxide, graphite, magnesium, silicone antimony, aluminum, metal salts such as LiClO₄, and LiAsF₆; and a variety of quaternary ammonium salts. Examples of the insulating filler include pigments, and silica.

In addition, other than the above-listed constituents, the below rubber compounds can be used in the belt substrate 51.

For instance, examples of a filler include titanium oxide, magnesium oxide, calcium carbonate, calcium sulfate, and the like; and clay, talc, silica, and the like. Examples of additives added to rubber include a vulcanizing agent, a vulcanization accelerator, an antioxidant, a plasticizer, and a process oil. Examples of a coloring agent include a variety of pigments.

No particular limitation is imposed on a method for manufacturing the belt substrate 51; however, for instance, the belt substrate 51 is manufactured as follows.

Here, a material including a blend of a chloroprene rubber (CR) and EPDM is taken as an example. To manufacture the belt substrate 51, the chloroprene rubber and EPDM, in which, for instance, a conductive filler is mixed and dispersed, are subjected to mixing by a mixer. After a vulcanizing agent is added thereto, the mixture is subjected to extrusion molding.

Here, for performing extrusion molding of the thus-mixed belt substrate 51, the belt substrate 51 is vulcanized in a state where the belt substrate 51 is caused to cover a cylinder whose outer diameter is identical with an inner diameter of a metal belt—which is called a vulcanization mandrel—under predetermined conditions (for instance, at 150° C. for 1 hour); and subsequently, the belt substrate 51 is subjected to secondary vulcanization under predetermined conditions (for instance, at 110° C. for 15 hours) with the time period being selected in accordance with a required modulus. Thereafter, the belt substrate 51 is caused to cover a polishing mandrel, whereby the inner periphery and the outer periphery of the belt substrate 51 are polished so that the surfaces thereof become smooth.

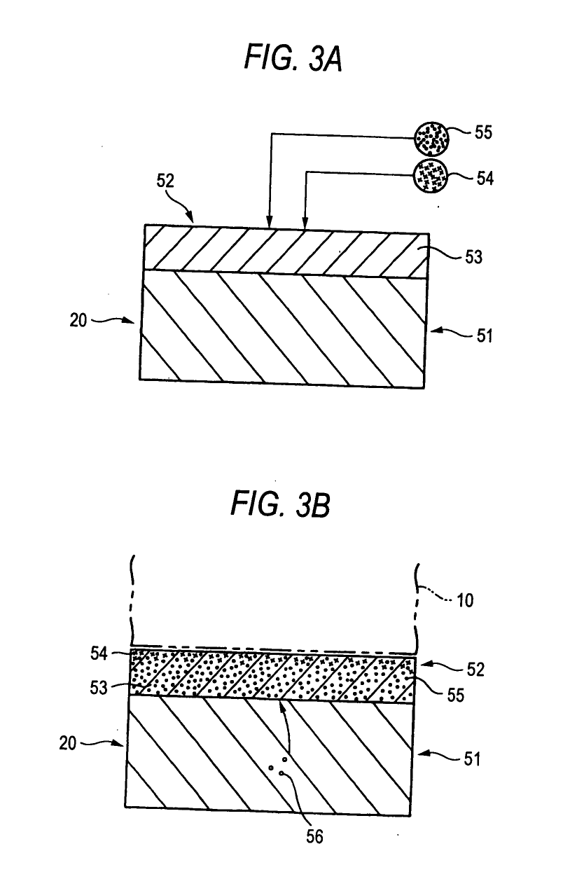

As shown in FIG. 3A, the coating layer 52 is formed by dispersing predetermined fillers—typically a hardness-retaining filler 55—in addition to a lubricant filler 54 in a polyurethane resin, a polyester resin, or an acrylic resin serving as a binder 53.

A volume resistivity of the coating layer 52 is set equal to or smaller than that of the belt substrate 51. For instance, when a volume resistivity of the belt substrate 51 is 7 to 13 LogΩ, that of the coating layer 52 is set to 7 to 13 LogΩ. Meanwhile, a volume resistivity in the embodiment is a value obtained by sandwiching a sample between two electrode plates of a predetermined area, and applying DC 100 V for 1 minute.

As the lubricant filler 54, resin powder of a fluoride compound, such as PTFE, ETFE, or PFA, is employed such that, as required, a surfactant is dispersed therein.

Meanwhile, as the hardness-retaining filler 55, there may be used either or both of a conductive filler and an insulating filler. A shape of the hardness-retaining filler 55 may be arbitrarily set; however, since the coating layer is thin, a particulate shape is preferable.

Examples of the conductive filler include metal oxides, such as carbon black, carbon white, titanium oxide, tin oxide, magnesium oxide, silicone antimony oxide, and aluminum oxide. Examples of the insulating filler include pigments and silica.

In particular, the hardness-retaining filler 55 is preferably filled in the ratio of 5 wt % or more in total based on the total weight of the resin binder. However, when the filling factor of the hardness-retaining filler 55 exceeds an upper limit value (e.g., 50 wt %), in the case of the conductive filler, resistance to leakage is deteriorated; and also in the case of the insulating filler, tear strength is decreased. Accordingly, the upper limit is preferably set to 50 wt % or lower.

A manufacturing method for the coating layer 52 is such that the lubricant filler 54 and the hardness-retaining filler 55 are mixed and dispersed in the resin binder 53, which is applied on the belt substrate 51 by dip coating, spray coating, electrostatic coating, roll coating, or the like. Surface roughness of the coating layer 52 may be adjusted by polishing the surface of the coating layer 52 by a polishing process (the intermediate transfer belt 20 is caused to cover a polishing mandrel, whereby the belt surface is polished).

At this time, as shown in FIG. 3B, in contrast to the hardness-retaining filler 55 being substantially uniformly dispersed in the resin binder 53 of the coating layer 52, the lubricant filler 54 is unevenly dispersed over the surface of the coating layer 52. This results from a specific gravity of the lubricant filler 54 being smaller than that of the hardness-retaining filler 55, and likely to be unevenly distributed on the surface of the resin binder 53.

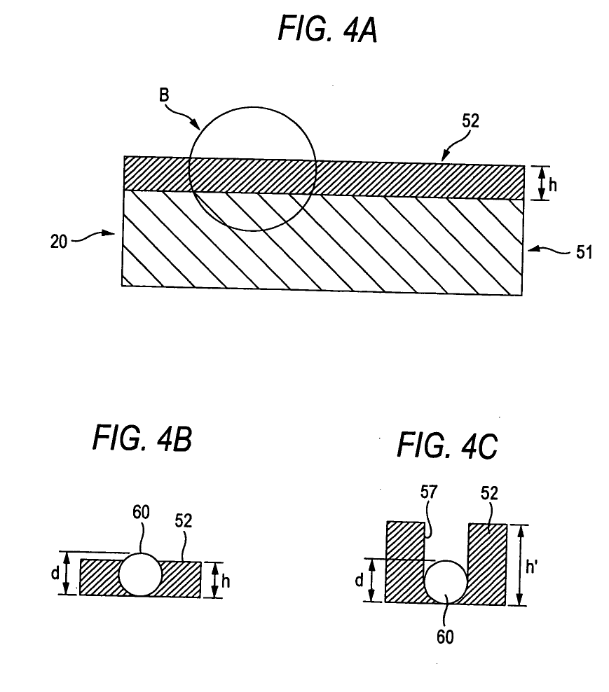

As shown in FIGS. 4A and 4B, in the embodiment a thickness “h” of the coating layer 52 is set equal to or smaller than an average particle size “d” of toner 60.

However, when the thickness “h” of the coating layer 52 is smaller than 3 μm, mechanical wear caused by the cleaning device may result in exfoliation of the coating layer 52, and the like; that is, durability required for mechanical strength may fail to be obtained.

In addition, in the embodiment, the surface roughness Rz (δ) of the coating layer 52 is set within the range of 1.5 μm to the average particle size of the toner.

The reason for setting the lower limit value of the surface roughness Rz of the coating layer 52 to 1.5 μm is as follows. When the surface roughness is smaller than 1.5 μm, production cost may be increased as a result of a long time being required for the polishing process, and the like; and the coating layer 52 and the photosensitive drum 10 may be easily brought into close contact.

Meanwhile, the reason for setting the upper limit value of the surface roughness Rz of the coating layer 52 to the average particle size of the toner or smaller is as follows. When the surface roughness Rz is greater than the particle size of the toner, applied toner (e.g., whose average particle size is 5 to 8 μm) is likely to be mechanically trapped on the intermediate transfer belt 20, thereby making the image forming apparatus prone to image defects such as halftone inconsistencies.

Next, operations of the image-forming apparatus configured as above will be described.

In FIG. 2A, when the image-forming apparatus starts image-forming operation, toner images of the respective color are sequentially formed on the photosensitive drum 10, and transferred onto the intermediate transfer belt 20 sequentially by a transfer electric field applied by the primary transfer roller 25.

Thereafter, the thus-transferred toner images on the intermediate transfer belt 20 are transferred onto the recording material 40 by a transfer electric field applied by the secondary transfer roller 30, and transported to a fixation process.

Meanwhile, residual toner on the intermediate transfer belt 20 is scraped off by the cleaning blade 26 serving as a belt-cleaning device.

In the above image-forming process, the intermediate transfer belt 20 comprises the belt substrate made from an elastic material whose Young's modulus is equal to or lower than 8 MPa. Accordingly, a pressure applied onto the intermediate transfer belt 20 in the course of transfer is uniformly dispersed, whereby voids or blur can be decreased.

In addition, as shown in FIG. 3A, the lubricant filler 54 is dispersed in a state of being unevenly distributed on the surface of the coating layer 52 on the intermediate transfer belt 20. Accordingly, frictional resistance of the intermediate transfer belt 20 against the photosensitive drum 10 is decreased, whereby lubricity between the photosensitive drum 10 and the intermediate transfer belt 20 is maintained favorable.

Furthermore, in the embodiment, at the time when the intermediate belt 20 is tensioned, a crack may be produced in the coating layer 52. At this time, since the coating layer 52 has a thickness “h” which is equal to or smaller than the average diameter of residual toner 60, as shown in FIG. 4B, the crack is shallow in depth, and the residual toner 60 is unlikely to be trapped in the crack region. Accordingly, even in the case where the residual toner 60 penetrates into the crack region of the coating layer 52, the residual toner 60 is scraped off by the cleaning blade 26 without fail.

In contrast, in a comparative embodiment shown in FIG. 4C, where the coating layer 52 has a thickness “h′” which is sufficiently thicker than the average particle size of the residual toner 60, the residual toner 60 is likely to be trapped in a crack region 57 of the coating layer 52, and hard to scrape off by the cleaning blade 26. Accordingly, the residual toner 60 is accumulated on the intermediate transfer belt 20, leading to inadequate cleaning.

In addition, in the embodiment, the coating layer 52 is formed such that the hardness-retaining filler 55 is dispersed in the resin binder 53 such as a polyurethane resin in a ratio of 5 wt % or more based on the total weight of the resin binder. Accordingly, the resin binder 53 exhibits thixotropy, whereby the coating layer 52 per se is assumed to be hardened to a certain level or more.

Under such a condition, even when the coating layer 52 absorbs moisture, hardness of the resin binder 53 is maintained, and the crack region of the coating layer 52 is not softened. In particular, even when the residual toner 60 is trapped in the crack region in the coating layer 52 by pressure applied during a secondary transfer, the crack maintains its shape. As a result, the residual toner 60 trapped in the crack region is scraped off by the cleaning blade 26 without fail.

Furthermore, since a decrease in hardness of the coating layer 52 is suppressed by the hardness-retaining filler 55, even when the photosensitive drum 10 and the intermediate transfer belt 20 are disposed in a contacting manner, complete close contact therebetween can be prevented.

As a result, as shown in FIG. 3B, a state where the photosensitive drum 10 and the intermediate transfer belt 20 are in complete close contact and brought into a vacuum condition is not generated. Accordingly, even when low-molecular-oily components 56 of the respective chemicals are present in the belt substrate 51, the low-molecular-oily components 56 are not exuded to the surface of the intermediate transfer belt 20, and a so-called bleeding phenomenon does not occur.

In addition, since the bleeding phenomenon can be prevented even when the photosensitive drum 10 and the intermediate transfer belt 20 are disposed so as to be brought into constant contact, a retracting mechanism for separating the photosensitive drum 10 and the intermediate transfer belt 20 is obviated. Accordingly, cost can be reduced by virtue of elimination of the retracting mechanism, and by potential employment of an inexpensive elastic material as the belt substrate 51.

Further, in the model of the embodiment, the intermediate transfer belt 20 is rotated in a following manner by a driving force of the photosensitive drum 10. Accordingly, cost for driving control of the intermediate transfer belt 20 can be significantly reduced.

Still further, since a contact width of the intermediate transfer belt 20 with the photosensitive drum 10 in the course of the primary transfer is set extremely wide; for instance, to 50 mm or longer, the intermediate transfer belt 20 can be driven in a stable manner, and, in addition, since no unnecessary gaps are formed in the vicinity of the transfer nip region, primary transfer is performed in a state free from splashing of the toner caused by discharge.

In the embodiment, in particular, since a wide transfer nip region between the photosensitive drum 10 and the intermediate transfer belt 20 is secured, pressure applied to the transfer nip region can be reduced. Accordingly, complete close contact between the photosensitive drum 10 and the intermediate transfer belt 20 can be avoided more reliably.

In the embodiment, the photosensitive drum 10 and the intermediate transfer belt 20 are brought into contact in a overlapping manner, and, in addition, the intermediate transfer belt 20 is rotated in a following manner by a driving force of the photosensitive drum 10. However, a configuration of the photosensitive drum 10 and the intermediate transfer belt 20 is not limited thereto. As a matter of course, the invention may adopt a configuration where the photosensitive drum 10 and the intermediate transfer belt 20 have separate driving systems, and the intermediate transfer belt 20 is brought into line contact with the photosensitive drum 10.

### Second Embodiment

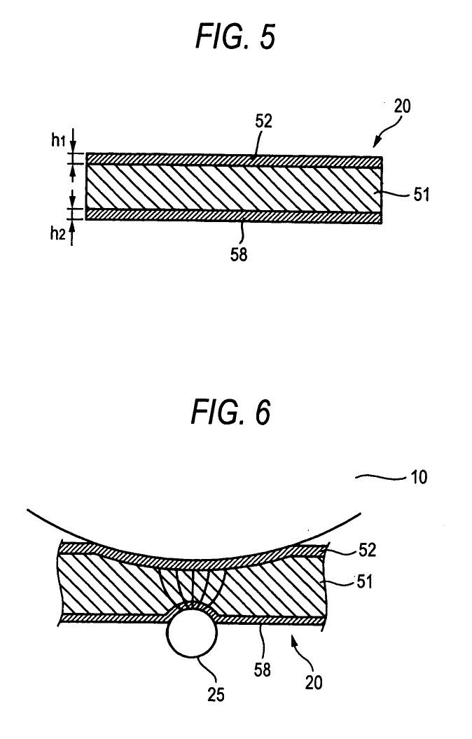

FIG. 5 is a view showing an essential portion of an intermediate transfer belt employed in a second embodiment.

In the drawing, the intermediate transfer belt 20 includes the belt substrate 51 made from an elastic material, a surface coating layer 52 for coating the surface of the belt substrate 51, and a backside coating layer 58 for coating the backside of the belt substrate 51.

In the embodiment, the basic constitution of the surface coating layer is substantially identical with that of the first embodiment, and the backside coating layer 58 is constituted substantially in the same manner as in the case of the surface coating layer 52. However, conductive fillers or insulating fillers to be filled therein can be adjusted as required.

Incidentally, the thickness “h1” of the surface coating layer 52 is necessary to be equal to or smaller than the average particle size “d” of the residual toner 60; however, no such restriction is imposed on the thickness “h2” of the backside coating layer 58, which can be selected as appropriate in consideration of a volume resistivity required of the intermediate transfer belt 20. Meanwhile, the volume resistivity value of the backside coating layer 58 measured under the same measurement conditions as in the first embodiment is 8 to 14 LogΩ, which is generally higher than that of the belt substrate 51.

In addition, when the surface of the backside coating layer 58 is smooth, the tension rollers 21 to 24 and the like may be brought into close contact with the intermediate transfer belt 20, possibly resulting in bleeding or the like. Therefore, the surface roughness Rz of the backside coating layer 58 is preferably 1.5 μm or larger.

According to the embodiment, the same effects as obtained in the first embodiment can be obtained. In addition, since the backside coating layer 58 is disposed on the backside of the belt substrate 51, the belt substrate 51 is not exposed to the outside air directly, whereby not only effects from ozone or the like generated inside the image forming apparatus can be alleviated, but also bleeding from the belt substrate 51 can be prevented.

More specifically, in an embodiment without the backside coating layer 58, when ozone or NOₓ is generated as a result of discharge, NOₓ, in particular, easily accumulates in recesses or over protrusions on exposed sections of the belt substrate 51. When the NOₓ reacts with water from the air, a highly-conductive layer may be formed on the backside of the belt substrate 51. Under the circumstances, there may arise apprehension that surface resistivity on the belt may be lowered as a result of deterioration of the backside on the belt substrate 51 and that transverse flow of transfer current may pose difficulty in exhibiting original transfer performance.

In contrast, in the embodiment, since the backside coating layer 58 is formed on the backside of the belt substrate 51, the embodiment is free from fear of the above-mentioned problem, and the intermediate transfer belt 20 is excellent in adaptation to environmental variations.

Furthermore, when the thickness “h2” of the backside coating layer 58 is appropriately selected, increase in resistance has no significant influence even in a low temperature/low humidity environment, whereby the transfer condition remains stabilized.

Furthermore, when a volume resistivity of the backside coating layer 58 is set to be sufficiently larger than that of the belt substrate 51, inconsistent resistance on the belt substrate 51 can be compensated by the backside coating layer 58 even when the primary transfer roller 25 is constituted of, for instance, a conductive material whose volume resistivity is 10⁶ Ω·cm or lower. Accordingly, a fluctuation in resistance of the intermediate transfer belt 20 can be suppressed to a small value, whereby stable transfer current can be supplied.

### EXAMPLES

### Example 1

The present example was directed toward a further embodiment of the intermediate transfer belt 20 used in the first embodiment. In the example, the filling factor of the hardness-retaining filler 55 was varied, and respective cleaning effects thereof were evaluated.

In the example, the intermediate transfer belt 20 was constituted as follows:
Belt substrate 51: configured by mixing a chloroprene rubber (CR) and EPDM, dispersing paraffin oil in the course of mixing, and adding a vulcanization accelerator to the EPDM;
Coating layer 52:
   thickness “h”: 3 to 6 μm;
   resin binder 53: polyurethane resin;
   lubricant filler 54: an aqueous resin of polyurethane emulsion (PTFE), in which a surfactant was dispersed as required, was filled in a ratio of 5 wt %; and
   hardness-retaining filler 55: carbon black was filled in a ratio of 0, 5, or 10 wt % as a conductive filler based on the total weight of the resin binder. However, in place of the conductive filler, a pigment or silica serving as an insulating filler may be filled in a predetermined weight ratio.

An OPC photosensitive material was used for the photosensitive drum 10.

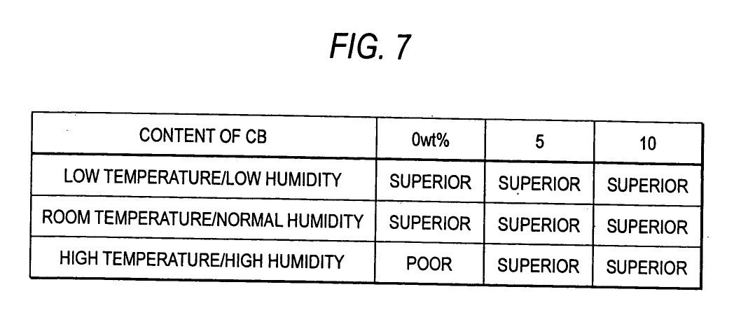

In the example, a test of cleaning performance was performed using the intermediate transfer belts 20 containing the hardness-restraining filler 55 indifferent filling factors, in a state where the photosensitive drum serving as an image carrier and the intermediate transfer belt were maintained in close contact, and in the respective environments of low temperature/low humidity (0.10° C./10%), room temperature/normal humidity (22° C./50%), and high temperature/high humidity (28° C./80%). The results are shown in FIG. 7.

In FIG. 7, evaluation results of the cleaning performance are shown as follows: “superior” indicates a condition where the effects of the cleaning were sufficiently exerted, and “poor” indicates a condition where the effects of the cleaning were exceedingly poor.

FIG. 7 shows that when the hardness-retaining filler 55 is contained in a filling factor of 5 wt % or more based on the total weight of the resin binder, effects of the cleaning can be sufficiently exerted.

### Example 2

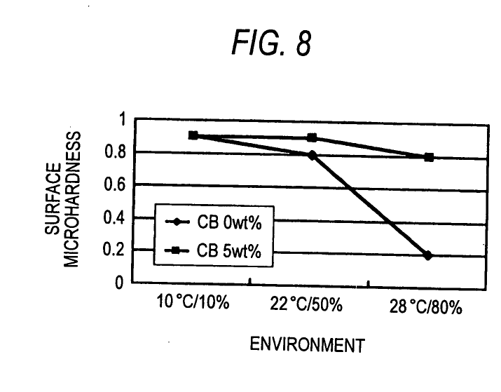

In example 2, surface microhardness of the intermediate transfer belts 20 was measured in the case where the intermediate transfer belts 20 whose constitution is identical with that of example 1 (the hardness-restraining filler 55 was filled in the coating layer 52 in a ratio of 5 wt % based on the total weight of the resin binder), and as comparative examples, in intermediate transfer belts whose coating layers 52 are not filled with the hardness-retaining filler 55 in the respective environments of low temperature/low humidity (10° C./10%), room temperature/normal humidity (22° C./50%), and high temperature/high humidity (28° C./80%). The results are shown in FIG. 8.

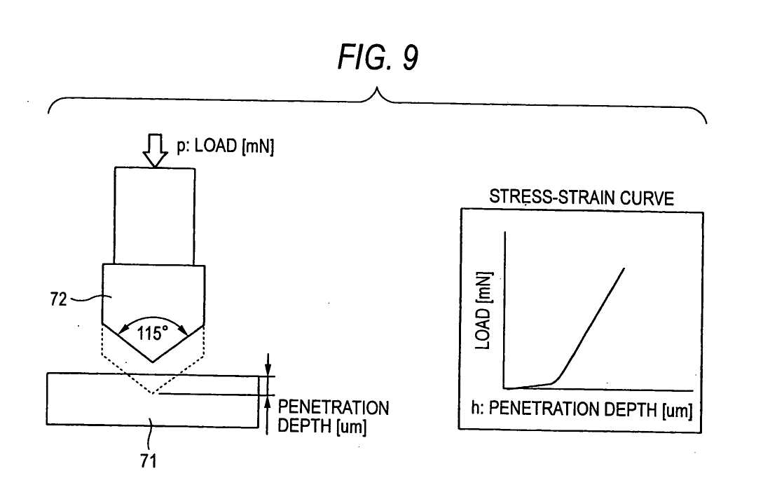

Here, a measurement principle of surface microhardness is shown in FIG. 9.

As shown in FIG. 9, the measurement principle of the surface mircrohardness is as follows. A predetermined load P (mN) is applied to the surface of a sample 71 (corresponding to the intermediate transfer belt 20) of the measurement object with use of a penetrator 72 of a predetermined shape (e.g., a triangular pyramid penetrator whose ridge angle is 115°). When the penetration depth of the penetrator 72 is taken as “y” (μm), the greater the surface microhardness, the smaller the penetration depth “y.” The surface microhardness DH[°] is represented by, e.g., the following equation:
DH [°]=α·P/y²
where, α is a coefficient (e.g., 3.8584) which is determined in advance in accordance with a shape of the penetrator 72, measurement conditions, and the like.

According to FIG. 8, in example 2, the surface microhardness was 0.9 in the low temperature/low humidity and room temperature/normal humidity environments, and was 0.8 even in the high temperature/high humidity environment.

In contrast, the comparative examples have shown that the surface microhardness was 0.9 in the low temperature/low humidity environment, 0.8 in the room temperature/normal humidity environment, and fell to as low as 0.2 in the high temperature/high humidity environment.

As described above, example 2 shows that a variation in the surface microhardness can be suppressed to 1/9≈0.11 (approximately 11%) within the range from the low temperature/low humidity environment to the high temperature/high humidity environment.

While changing constitutional conditions (e.g., a filling factor of the hardness-retaining filler 55) of the intermediate transfer belt 20, surface microhardness relative to the respective intermediate transfer belts had been measured within the range from the low temperature/low humidity environment to the high temperature/high humidity environment, which shows that variations in surface microhardness were suppressed to 20% or less.

### Example 3

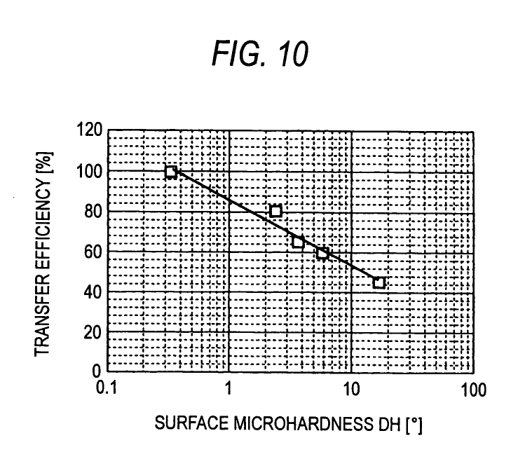

In example 3, a line image of a predetermined color on the photosensitive drum 10 was caused to be transferred onto the intermediate transfer belts 20 by use of an intermediate transfer belt 20 identical with that of example 1 (the hardness-restraining filler 55 was filled in the coating layer 52 in a ratio of 5 wt % based on the total weight of the resin binder), while the surface microhardness [°] of the intermediate transfer belt 20 was varied. The results are shown in FIG. 10.

According to FIG. 10, there is a correlation of 96% between surface microhardness of the intermediate transfer belt 20 and transfer efficiency. In the embodiment, for instance, when the surface microhardness is equal to or lower than 1.5, a transfer efficiency higher than 80% can be obtained.

Meanwhile, the same experiments were performed while the constitutional condition of the intermediate transfer belt 20 was changed (e.g., filling factor of the hardness-retaining filler 55). The results indicate that a transfer efficiency higher than 80% can be obtained when the surface microhardness is equal to or lower than 1.5.

1. A transport belt which can carry an image formed by an image-forming particle, comprising:
a belt substrate comprising an elastic material; and
a coating layer coating a first surface of the belt substrate,
wherein the coating layer has a thickness which is equal to or smaller than an average particle size of the image-forming particle, and a hardness-retaining filler capable of suppressing a drop in surface microhardness is dispersed in the coating layer.

2. The transport belt according to claim 1, wherein the coating layer comprises a resin binder and a lubricant filler capable of inducing lubricity dispersed in the resin binder.

3. The transport belt according to claim 1, wherein 5 wt % or more of hardness-retaining filler is dispersed in the coating layer.

4. The transport belt according to claim 1, wherein the hardness-retaining filler includes at least one of conductive filler and insulating filler.

5. The transport belt according to claim 1, wherein
a value of the coating layer measured with Shimadzu dynamic ultramicrohardness meter DUH-201S through use of a triangular pyramid indenter having a ridge angle of 115° is suppressed to 20% or lower a difference between a hardness measurement value obtained in a hot and humid environment and a hardness measurement value obtained in a cool and low-humidity environment.

6. The transport belt according to claim 1, wherein the belt substrate comprising an elastic material having Young's modulus of 8 MPa or lower.

7. The transport belt according to claim 1, wherein the belt substrate comprising an elastic material having Young's modulus of 2.8 MPa to 3.8 MPa.

8. The transport belt according to claim 1, wherein the belt substrate comprising an elastic material having rupture strength of 10 MPa or more.

9. The transport belt according to claim 1, wherein the belt substrate comprising an elastic material having elongation of 300% or more and permanent elongation of 5% or more.

10. The transport belt according to claim 1, wherein the belt substrate comprising an elastic material having tearing strength of 20 kN/m or more.

11. The transport belt according to claim 1, wherein the belt substrate comprising an elastic material having hardness in accordance with JIS K6253 of 68° to 78°.

12. The transport belt according to claim 1, wherein the belt substrate comprises at least one of a chloroprene rubber and an epichlorohydrin rubber.

13. The transport belt according to claim 1, wherein the coating layer comprises a conductive filler selected from the group consisting of carbon black, Ketjen black, acetylene black, zinc oxide, potassium titanate, titanate potassium, titanium oxide, tin oxide, graphite, magnesium, silicone antimony, aluminum, LiClO₄, and LiAsF₆ and a quaternary ammonium salt.

14. The transport belt according to claim 1, wherein the coating layer has a thickness of 3 μm or more.

15. The transport belt according to claim 1, wherein the coating layer coats a second surface which is a backside of the first surface.

16. An image forming apparatus comprising:
an image carrier; and
a transport belt which opposes to the image carrier and can carry an image formed by an image-forming particle, the transport belt comprises a belt substrate comprising an elastic material and a coating layer coating a surface of the belt substrate,
wherein the coating layer has a thickness which is equal to or smaller than an average particle size of the image-forming particle, and a hardness-retaining filler capable of suppressing a drop in surface microhardness is dispersed in the coating layer.

17. The image forming apparatus according to claim 9, further comprising:
a cleaning member capable of scraping off a residual image-forming particle on the transport belt.
